(19) United States
(12) Patent Application Publication
(10) Pub. No.: US 2014/0065303 A1
(43) Pub. Date: Mar. 6, 2014

(54) HOLDING DEVICE FOR OPTICAL ELEMENT

(71) Applicants: Robert Dennis Grejda, Fairport, NY (US); Keith Ernest Handford, Macedon, NY (US)

(72) Inventors: Robert Dennis Grejda, Fairport, NY (US); Keith Ernest Handford, Macedon, NY (US)

(21) Appl. No.: 13/792,964

(22) Filed: Mar. 11, 2013

Related U.S. Application Data
(60) Provisional application No. 61/695,739, filed on Aug. 31, 2012.

(51) Int. Cl. B05C 13/02

(52) U.S. Cl. CPC B05C 13/02
USPC 427/162; 118/500

(57) ABSTRACT

A support apparatus for coating optical surfaces has a platen having one or more holes, wherein each of the one or more holes in the platen is featured to seat one or more edges of an optical element against the platen during surface coating, wherein the platen is formed of a machinable glass ceramic.

### CROSS REFERENCE TO RELATED APPLICATIONS

This application claims the benefit of U.S. Provisional Patent Application Ser. No. 61/695739, filed on Aug. 31, 2012, entitled “HOLDING DEVICE FOR OPTICAL ELEMENT” in the names of Robert D. Grejda et al., the contents of which are incorporated fully herein by reference.

### FIELD OF THE INVENTION

This invention generally relates to a holding device for supporting a lens or other optical element and more particularly relates to apparatus for supporting an optical element during surface treatment, such as during coating deposition.

### BACKGROUND

Optical coatings for lenses and other types of optical elements are often deposited onto the surface of the optical element under vacuum and at high temperatures. Typically, optical coatings are applied in multiple, thin layers to provide various optical characteristics such as for antireflection and filtering. In order to deposit the optical coating layers in a uniform manner over the full aperture of the optical element, ambient conditions within the coating chamber are carefully controlled. Various types of specialized mounting apparatus are employed as holding devices for the lenses or other elements undergoing coating treatment. Holding devices are carefully designed for the demands of the coating environment, with special attention paid to maintaining the optical elements in position without mechanical stress in order to minimize distortion, scratching, or other damage to the optical element. Thermal factors during heating, processing, and cooling phases are also a consideration. Care must be taken to match thermal characteristics of the materials used for mechanical mounting with thermal characteristics of the materials that are used in the lenses or other optical components.

Crystalline materials such as calcium fluoride (CaF₂) are widely used for lenses and other optical elements in applications that direct high-power ultraviolet (UV) light to a target, such as in microlithography for microcircuit fabrication, for example. Optical elements formed from this type of crystalline material enjoy inherent advantages including low dispersion, high bandwidth capability, and suitability for handling high-intensity radiation. Optical elements formed from CaF₂ are typically fabricated with tight tolerances for surface shape, element thickness, radius of curvature, and surface uniformity, often requiring multiple iterations of conventional and deterministic polishing techniques for their final preparation.

Once the CaF₂ optics surfaces are properly polished, various types of coatings can then be applied. However, applying coatings to CaF₂ lenses can be particularly challenging. As noted earlier, a vacuum chamber is used, with high temperatures needed for successful deposition of the coating materials. Weight, or more properly stated, mass of the optical component(s) being coated is another consideration. Some types of lenses formed from CaF₂ are relatively large in diameter and thus of comparatively large mass. Even where the lenses or other optical elements are of moderate size, it is generally more efficient to coat a number of lenses at the same time. Thus, whether the coating is applied to a few large lenses or to a number of smaller lenses within the coating chamber, support structures that hold the lenses or other optical elements must be capable of accommodating their size and weight within the coating chamber.

The crystalline CaF₂ material itself has characteristics that complicate the task of handling the optical element during coating. Shear stress at high processing temperatures, for example, can cause crystal lattice shift, distorting or ruining the surface shape. Temperature characteristics of the crystalline lens substrate can vary significantly from those of mount materials, particularly with respect to thermal absorption and conductivity.

The support mechanism for holding lenses and other optical components that are formed from crystalline materials such as CaF₂ must be able to satisfy a number of requirements, including the following:
(i) Support the mass of the optical element. As noted previously lenses, prisms, and other optical elements formed from crystalline materials can be large and relatively heavy, or there can be a number of smaller optical elements being coated simultaneously. For this reason, metallic materials are conventionally used for support structures. Dynamic loading is a consideration as well for support structures, since the optical elements can be in movement about rotational axes or along orbital paths within the coating chamber.
(ii) Expose the optical surface area for coating application. The full surface area to be coated must be exposed in order to provide uniform coverage. Thus, not only must the weight of the optical components be supported, but minimal contact and obstruction are allowed for the surfaces to be treated.
(iii) Minimize thermal absorption and conductance. Temperature gradients within the element, such as at the interface between the optical element and supporting structures, can cause crystal lattice slip, thereby deforming the surface shape. Transfer of thermal energy between the optical element and its support mechanism should be reduced to as low levels as possible and should be uniform, without an appreciable temperature gradient along any interface between the mounting and the optical element. This is complicated by the fact that crystalline materials respond slowly to the radiant heating wavelengths typically used within the vacuum coating chamber. Metals, on the other hand, respond more quickly to the radiant energy, potentially causing unwanted gradient temperature effects near the interface between the optical element and its support.
(iv) Withstand vacuum and temperature conditions of the coating chamber. Coatings are applied in vacuum and at relatively high temperatures, typically exceeding 200 degrees C. Supporting structures must not only be stable under these temperature conditions, but must also be well thermally matched for heating and cooling phases.

It can be appreciated that these can be conflicting requirements. For example, a number of materials suitable for supporting component weight, as noted in (i) above, provide poor behavior due to thermal conductance, as noted in (iii) above. In some conventional devices, metals used for supporting structures can absorb radiant energy much more quickly than the crystalline optical components. To counteract this effect, components of the metal support structures are often treated in some way to compensate for inherent thermal characteristics, such as using reflection. Thus, for example, some support embodiments employ a reflective coating applied over metal support components. This type of reflective coating, often using gold or other costly material, can help to reduce absorption of radiant energy that is applied for heating the lens or other element. However, when using such a coating, periodic cleaning, renewal, or re-application of the support element surface is required to maintain sufficient reflectivity.

In addition to requirements (i)-(iv) listed above, factors of cost, relative complexity, adaptability to different optical elements, size, and component lifetime are also considerations for design and use of a support mechanism for coating crystalline optics.

Thus it is seen that there is a need for apparatus and methods for supporting various types of optical elements within a vacuum coating chamber.

### SUMMARY

It is an object of the present invention to advance the art of optical coating processing for optical components, particularly components formed from crystalline materials. With this object in mind, the present invention provides a support apparatus for coating optical surfaces, the support apparatus comprising a platen having one or more holes, wherein each of the one or more holes in the platen is featured to seat one or more edges of an optical element against the platen during surface coating, wherein the platen is formed of a machinable glass ceramic.

A feature of the present invention is the use of machinable ceramic materials for supporting optical elements within the vacuum coating chamber.

An advantage of the present invention is the capability to seat the optical element that is to be coated directly against the surface of a supporting structure, without requiring a succession of intermediate components for reducing thermal conductivity and absorption.

Other desirable objectives, features, and advantages of the disclosed invention may occur or become apparent to those skilled in the art. The invention is defined by the appended claims.

### BRIEF DESCRIPTION OF THE DRAWINGS

FIG. 1 is a schematic block diagram that shows components of a vacuum coating system for optical elements.

FIG. 2 is a perspective view that shows a support platen according to an embodiment of the present invention.

FIG. 3 is a side view of a portion of the support platen holding an optical element.

FIG. 4 is a perspective view that shows a support platen having a retainer element for seating against the optical element.

FIG. 5A is a side view that shows a portion of the support platen holding a retainer element that, in turn, supports an optical element.

FIG. 5B is a side view that shows a portion of the support platen holding two retainer elements that support an optical element.

FIG. 6 is a perspective view showing a support platen that has holes featured for coating prism surfaces.

FIG. 7A is a schematic block diagram that shows components of a vacuum coating system for optical elements using the platen of the present invention.

FIG. 7B is a schematic block diagram that shows components of a vacuum coating system for optical elements, wherein outer edges of the platens are featured with gear teeth for rotation about their central axes.

### DETAILED DESCRIPTION

Figures shown and described herein are provided in order to illustrate key principles of operation and fabrication for apparatus according to various embodiments and a number of these figures are not drawn with intent to show actual size or scale. Some exaggeration may be necessary in order to emphasize basic structural relationships or principles of operation.

In the context of the present disclosure, terms “top” and “bottom” or “above” and “below” are relative and do not indicate any necessary orientation of a component or surface, but are used simply to refer to and distinguish opposite surfaces or different light paths within a component or block of material. Similarly, terms “horizontal” and “vertical” may be used relative to the figures, to describe the relative orthogonal relationship of components or light beams that align in different planes, for example, but do not indicate any required orientation of components with respect to true horizontal and vertical orientation.

Where they are used, the terms “first”, “second”, and so on, do not necessarily denote any ordinal or priority relation, but may be used for more clearly distinguishing one element or time interval from another.

The term “prism” or “prism element” is used herein as it is understood in optics, to refer to a transparent optical element that is generally in the form of an n-sided polyhedron with one or more flat surfaces upon which light is incident and that is formed from a transparent, solid material that refracts light. It is understood that, in terms of shape and surface outline, the optical understanding of what constitutes a prism is less restrictive than the formal geometric definition of a prism and encompasses that more formal definition. Moreover, the term “prism” may be used to describe a single, monolithic piece of substrate or to describe an assembly that uses an arrangement of prisms that may be in optical contact with each other or, alternately, may have a fixed air gap between them.

Embodiments of the present invention provide apparatus and methods for supporting lenses, prisms, and other types of optical elements during coating operations. Unlike conventional approaches for optical element support, embodiments of the present invention employ materials and methods that help to reduce the overall number of components that are needed within the coating chamber and to provide solutions that reduce the likelihood of thermal gradients that can cause damage to the lens surface shape.

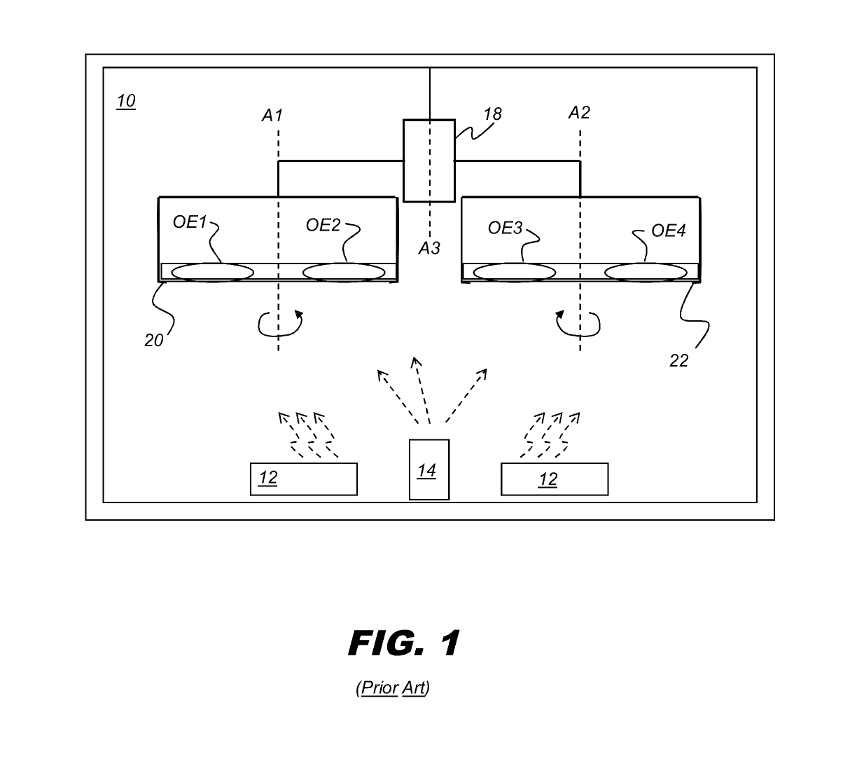

By way of reference, the schematic block diagram of FIG. 1 shows a conventional coating chamber 10 that provides vacuum and temperature conditions suitable for depositing an optical coating onto one or more optical elements OE1 and OE2 on a holder 20 and optical elements OE3 and OE4 on a holder 22. Rotation of the optical elements helps to provide uniform coating conditions. A transport mechanism 18 provides rotation of holders 20 and 22 about axes A1 and A2 respectively. Rotation may also be provided about an axis A3, between axes A1 and A2. Within coating chamber 10 are one or more heaters 12 for providing radiant heat energy. A source 14 provides the material to be deposited in vapor form.

Within coating chamber 10, coating layers are deposited on the surfaces of optical elements OE1-OE4 under high vacuum (such as <10⁻⁶ Torr), and at temperatures that typically range from 200 to 300 degrees C.

As was noted earlier in the background section, conventional solutions provided for holding the optical elements within coating chamber 10 can be complex and are often compromised in performance. Embodiments of the present invention use alternate approaches for optical element mounting, with materials that offer improved thermal performance without compromising the structural strength and broad area coverage that is needed for coating crystalline lenses and other optical elements.

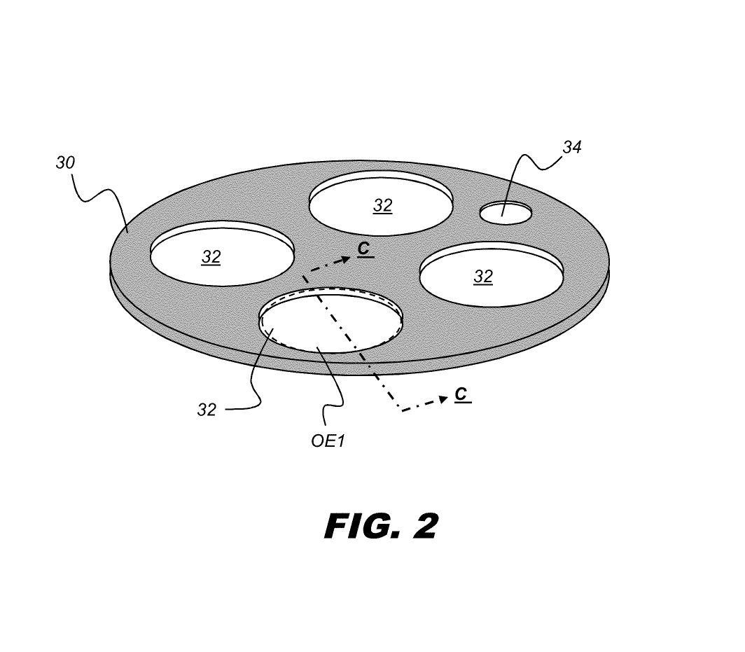

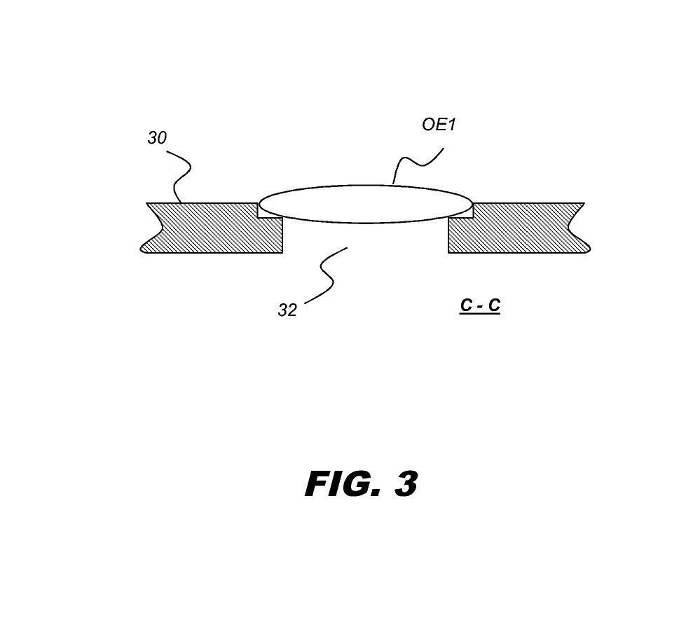

The perspective view of FIG. 2 shows a platen 30 having one or more holes 32 that are suitably featured for seating optical elements during coating. An additional witness hole 34 is optionally provided for holding a “witness” element or test sample that can be observed during coating, such as an element having a plano surface, for example. The side view of FIG. 3 shows how hole 32 in platen 30 is featured, machined to seat optical element OE1 along its edge.

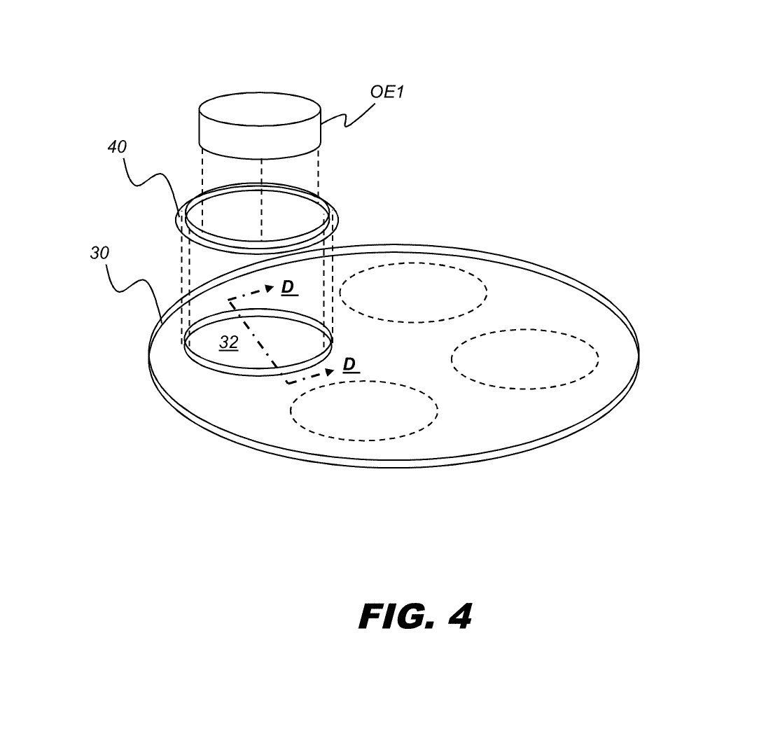

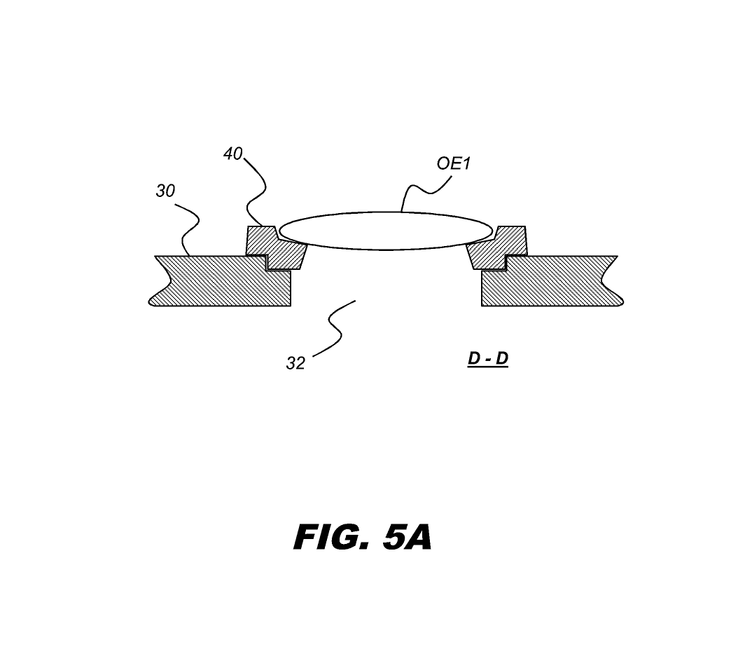

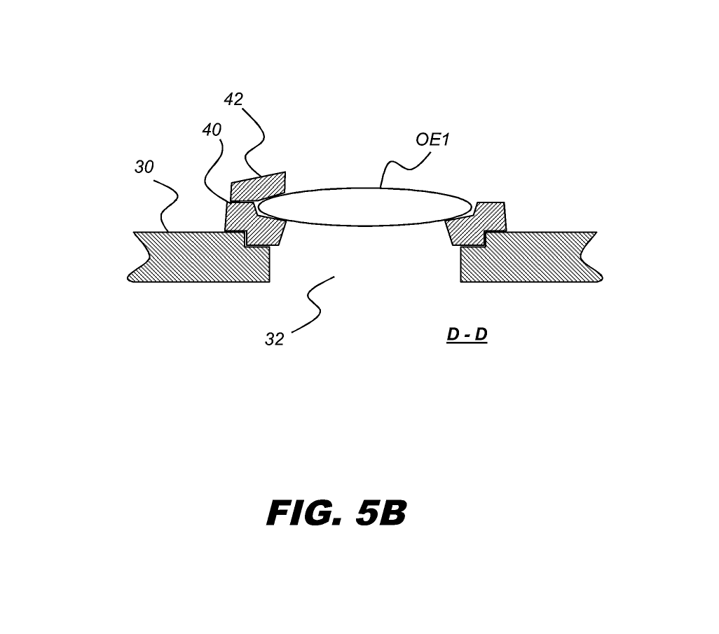

The perspective view of FIG. 4, in exploded view form, shows platen 30 in an alternate embodiment. One or more of holes 32 are used to seat an intermediary retainer element 40. Retainer element 40 is machined to seat against one or more edges of optical element OE1 that fit within retainer element 40. The side view of FIG. 5A shows how hole 32 in platen 30 is machined, featured to seat retainer element 40 with optical element OE1, in turn, seated along its edge. The side view of FIG. 5B shows an alternate embodiment of the present invention in which a second retainer element 42 is also provided. Second retainer element 42 is positioned along the opposite side of optical element OE1, which may be advantageous in some applications. Retainer element 42 may extend fully around the perimeter of optical element OE1 or may be a tab or other element that maintains only a small contact area with the opposite side of optical element OE1 and may or may not completely cover the opposite side of the optical element. Retainer element 42 seats against the first retainer element 40 and along an edge of the optical element OE1. Retainer element 42 is also formed from a machinable glass ceramic.

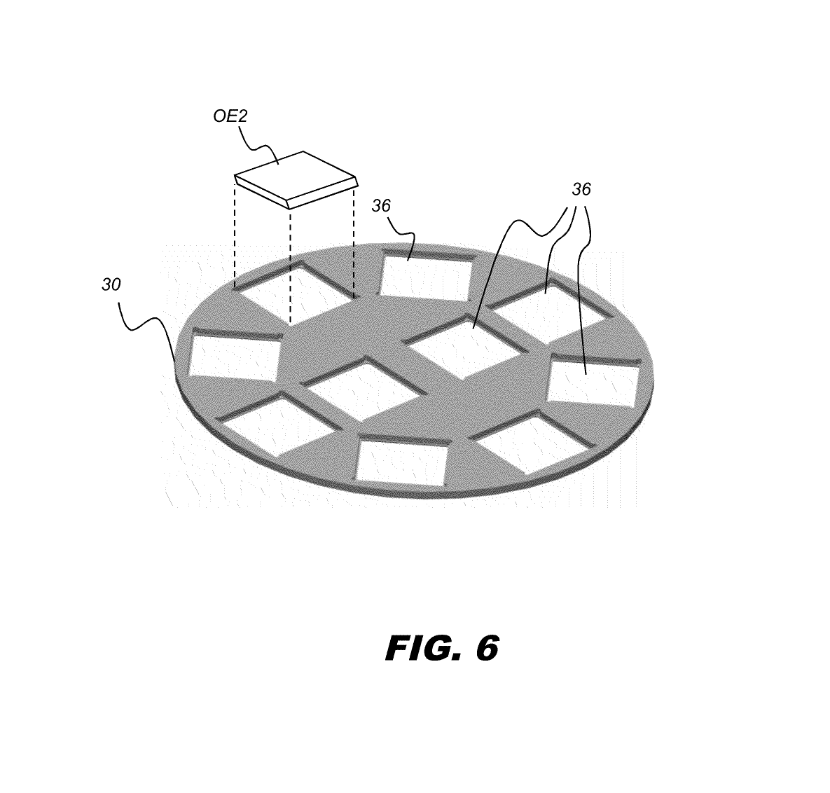

The perspective view of FIG. 6 shows an alternate embodiment in which platen 30 has holes 36 of a rectangular shape. Optical element OE2 can be a prism, plate, or other optical component, seated within hole 36 in a manner similar to that shown in the side view of FIG. 3. According to an alternate embodiment, retainer element 40 (FIG. 4, 5A) adapts the shape of hole 32 or 36 appropriately to accommodate different optical element shapes.

In order to meet requirements for reduced thermal conductivity and absorption, while still providing sufficient structural strength to support the weight of the optical elements, embodiments of the present invention form platen 30 from a machinable glass ceramic material. This class of materials includes various ceramics that can be formed using machining equipment and techniques that are used for steel, aluminum, and other metals. However, unlike metal materials, machinable ceramics such as Macor® Machinable Glass Ceramic from Corning, Inc., Corning, N.Y., enjoy favorable thermal characteristics of ceramic materials, particularly with respect to thermal absorption and thermal conductivity. Macor ceramic, composed of a combination of fluorophlogopite mica and borosilicate glass, can be machined to very high tolerances, up to 0.0005 in. and machined to a surface finish of less than 20 μin and polished to a smoothness of up to about 0.5 μin. This material can withstand continuous use temperatures of 800 degrees C., with peak temperatures at 1000 degrees C. Its thermal conductivity at 25 degrees C. is about 1.46 W/m degrees C.

In the context of the present disclosure, the descriptive term “machinable” applies to materials that can be machined to at least 0.005 in. using conventional high-speed machine tooling practices and tools. Machinable materials can be featured using various types of machining equipment, including grinding, polishing, sawing, turning, milling, drilling, and tapping equipment, for example. The machinable glass ceramic materials that are used can be cast to the needed shape for forming platen 30, then optionally machined as needed for providing features for supporting optical elements.

Machinable glass ceramics, also termed in hyphenated form as “glass-ceramics”, are formed from various combinations of crystalline ceramic materials with glass materials. In general, the weight-percentage of glass material in the machinable glass ceramic is appreciable, with weight-percentage values for SiO₂ such as 25% and higher, for example. Other types of machinable glass ceramics include materials described in commonly assigned U.S. Pat. No. 8,021,999 entitled “High Strength Machinable Glass-Ceramics” to Beall. The materials described in the Beall '999 disclosure include some portion of mica crystalline materials combined with amorphous glass materials. Other machinable glass ceramic materials are formed as combinations of glass materials with other types of crystalline materials, including non-mica crystalline materials. By way of reference, commonly assigned U.S. Pat. No. 2,920,971, entitled “Method of Making Ceramics and Product Thereof” to Stookey, provides information on practical aspects and theoretical considerations for the manufacture of machinable glass ceramics as well as a discussion of crystallization aspects for their fabrication. In addition to Macor, other commercially available machinable glass ceramics include DICOR® (Corning Incorporated, Corning, N.Y.), Vitronit (Vitron Spezialwerkstoffe GmbH, Jena, Germany), a glass ceramic having cabbage-head microstructure of mica crystals; and Photoveel (Sumikin Photon Ceramics Co., Ltd., Japan), a fluoromica type glass ceramic that also contains zirconia microcrystals in the glass matrix.

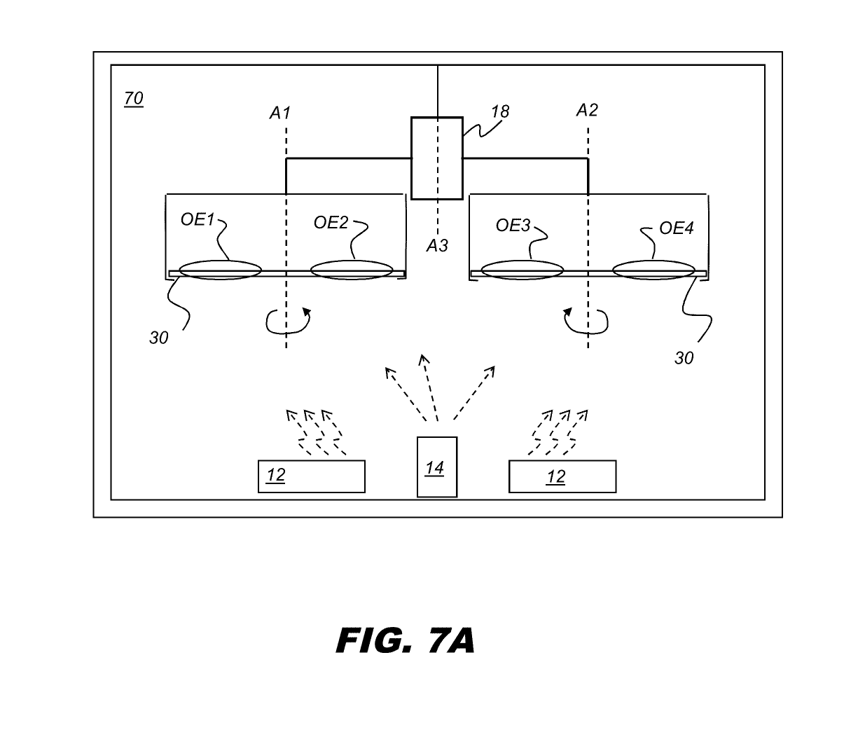

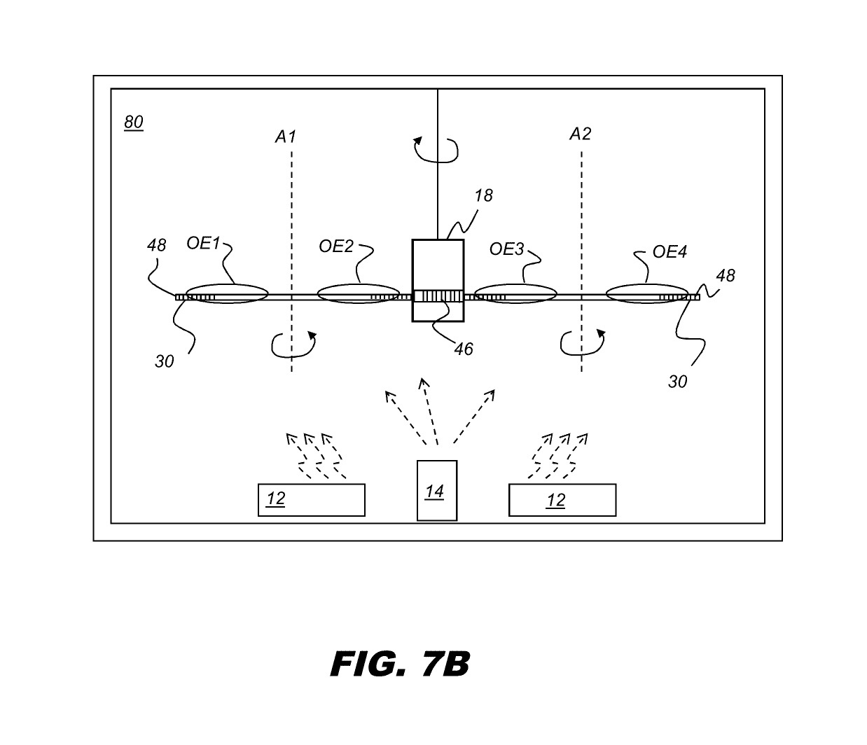

The schematic block diagram of FIG. 7A shows a coating chamber 70 that has optical elements OE1, OE2, OE3, and OE4 seated on two platens 30 formed according to an embodiment of the present invention. Similar to the arrangement shown in FIG. 1, platens 30 are coupled with a transport apparatus. Transport mechanism 18 provides rotational motion for each platen about axes A1, A2, and optionally about axis A3, during the coating process. Heater 12 and source 14 components operate in similar manner to those for conventional devices, as described with respect to FIG. 1. Axes A1, A2, and A3 are shown as vertical axes in FIG. 7A. However, embodiments of coating chamber 70 could use platen 30 with rotational axes at other angles.

The schematic block diagram of FIG. 7B shows an alternate embodiment of a coating chamber 80 in which transport mechanism 18 rotates platens 30 directly by means of geared teeth 46 that engage with geared teeth 48, machined along the edge of both platens 30. According to an alternate embodiment, each platen 30 is mechanically coupled to a central gear mechanism provided by transport mechanism 18. Because platen 30 is formed from a machinable ceramic material, the same component that holds the optical element for coating can also be machined with gear teeth. This enables supporting platen 30 to act as part of the transport mechanism for moving the optical element during the coating process. Any of a number of types of gear arrangements can be used, such as providing platen 30 edges with peripheral geared teeth for helical, double-helical, spur, and worm gears, for example.

Embodiments of the present invention reduce the number of number of components needed for seating a lens or other optical element within a vacuum coating chamber. Unlike embodiments that use metal components for support elements and require a precious-metal coating for reflecting radiant heat away from the support mechanism, embodiments of the present invention do not require added surface treatment for platen 30 beyond initial machining and polishing.

Embodiments of the present invention are particularly suitable for supporting lenses and other optical elements formed from CaF₂ and other crystalline materials, as well as for lenses formed from glass, plastics, or other materials.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. The invention is defined by the claims.

1. A support apparatus for coating optical surfaces, the support apparatus comprising a platen having one or more holes, wherein each of the one or more holes in the platen is featured to seat one or more edges of an optical element against the platen during surface coating, wherein the platen is formed of a machinable glass ceramic.

2. The support apparatus of claim 1 wherein the optical element is taken from the group consisting of a lens and a prism.

3. The support apparatus of claim 1 wherein the machinable glass ceramic is formed of a combination of borosilicate glass with fluorophlogopite mica.

4. The support apparatus of claim 1 wherein an outer edge of the platen is featured with geared teeth for platen rotation during coating.

5. The support apparatus of claim 1 wherein the optical element is formed from a crystalline material.

6. The support apparatus of claim 1 wherein the support apparatus is coupled with a transport apparatus that provides movement to the optical element during coating.

7. A support apparatus for coating optical surfaces, the support apparatus comprising a platen having one or more holes, wherein at least one of the one or more holes is machined to seat against one or more edges of a first retainer element during surface coating, wherein the first retainer element is machined to seat against one or more edges of an optical element during surface coating and wherein both the first retainer element and the platen are formed of a machinable glass ceramic.

8. The support apparatus of claim 7 further comprising a second retainer element that seats against the first retainer element and along one or more edges of the optical element, wherein the second retainer element is also formed of a machinable glass ceramic.

9. The support apparatus of claim 7 wherein the optical element is taken from the group consisting of a lens and a prism.

10. The support apparatus of claim 7 wherein an outer edge of the platen is featured with geared teeth for platen rotation during coating.

11. A method for coating a surface of a crystalline optical element, the method comprising:
a) providing a support apparatus that comprises a platen having a hole that is machined with features for seating the optical element, wherein the platen is formed of a machinable glass ceramic;
b) seating the optical element within the machined hole in the platen; and
c) depositing at least one coating layer on the optical element at a predetermined vacuum level range and temperature.

12. The method of claim 11 wherein the optical element is formed from a crystalline material.

13. The method of claim 11 wherein seating the optical element further comprises seating the optical element within a retainer element.

14. The method of claim 10 further comprising rotating the platen while depositing the at least one coating layer.
